(19) United States
(12) Patent Application Publication
(10) Pub. No.: US 2013/0054345 A1
(43) Pub. Date: Feb. 28, 2013

(54) DATA MINING

(71) Applicants: Erik Stephen Ross, Charlotte, NC (US); Mei-Ling In Johnson, Wilmington, DE (US); Bhupendra Rathore, Newark, DE (US); Alexander Azariy Shenkar, Roswell, GA (US); Susan S. Thomas, Gastonia, NC (US)

(72) Inventors: Erik Stephen Ross, Charlotte, NC (US); Mei-Ling In Johnson, Wilmington, DE (US); Bhupendra Rathore, Newark, DE (US); Alexander Azariy Shenkar, Roswell, GA (US); Susan S. Thomas, Gastonia, NC (US)

(73) Assignee: BANK OF AMERICA CORPORATION, Charlotte, NC (US)

(21) Appl. No.: 13/216,387

(22) Filed: Aug. 24, 2011

(51) Int. Cl. G06Q 30/00; G06Q 40/00

(52) U.S. Cl. 705/14.39; 705/14.1

(57) ABSTRACT

A method, apparatus, computer-readable medium and system are disclosed for acquiring data with respect to a user. In some embodiments, a computational algorithm may determine whether to provide one or more products and/or services to a user. The products and/or services may be related to banking. In some embodiments, a device may receive a request for products/services. After an initial examination of the request, the device may make a determination that more information is needed. A request for the additional information may be transmitted, and the transmitted request may include one or more incentives for voluntarily disclosing the information. In some embodiments, the requested additional information may include verified income and/or expenses. A response to the request for additional information may be received at the device. The device may analyze the response and may extend an offer for products/services. The device may further include in the offer at least one incentive as a function of information included in the response.

### FIELD

Aspects of the present disclosure relate to data mining. More specifically, aspects of this disclosure relate to acquiring information to determine whether to extend a product or service offering to an individual.

### BACKGROUND

Improvements in computing technologies have changed the way people interact with one another, as well as how people acquire products and services and conduct business. For example, a user may use a web browser to view a bank statement, to pay a bill, and to apply for a mortgage or loan.

From the perspective of a product/service provider, difficult decisions frequently need to be made as to whether to extend a product or service to a particular user (which may include a person, a business, a partnership, etc.). For example, a bank may have a limited amount of information with which to make a decision with respect to a user's application for a checking account. Related questions arise regarding the terms of the product/service offering. Continuing the above example, if the bank elects to extend a checking account to the user, the bank will also need to determine the terms (e.g., fees, penalties for bounced checks, etc.) to be associated with the offer.

In some instances, an incomplete picture of a user's history may cause a product/service provider to take on more risk than is warranted or justified. For example, if a user represents a greater risk than the product/service provider calculated or estimated, the product/service provider is exposed to greater liability (e.g., probability of loss). Similarly, if the user represents less of a risk than the product/service provider calculated or estimated, the user may decline the product/service offer, which may result in a missed business opportunity for the product/service provider and/or the user.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to an apparatus, method and system for targeting users with one or more product or service offerings. In some embodiments, a user might not have previously engaged in a transaction with a product/service provider. In those embodiments, the product/service provider might have a limited amount of information regarding the user. For example, the product/service provider may have a “thin file” regarding the user.

In some embodiments, and particularly those embodiments where the product/service provider has a “thin file” regarding the user, the product/service provider may offer one or more incentives to the user in order to obtain additional information regarding the user (e.g., in order to expand or supplement the “thin file”). In some embodiments, the additional information may include the user's verified income, which may be evidenced via a tax related form (e.g., a W-2 form, a 1040 form, etc.), a pay stub, or the like. In some embodiments, the one or more incentives that the product/service provider may offer may include one or more of an annual percentage rate (APR) discount, free or discounted (tax) form preparation, cash back, a rebate for purchasing another product/service, or the like.

In some embodiments, the product/service provider may determine whether to offer a product or service to a user based at least in part on the additional information provided by the user. In some embodiments, the product/service provider may determine what terms are to accompany a product/service offering based at least in part on the additional information provided by the user.

### BRIEF DESCRIPTION OF THE DRAWINGS

The present disclosure is illustrated by way of example and not limited in the accompanying figures in which like reference numerals indicate similar elements.

FIG. 1 illustrates an example computing environment in which various aspects of the disclosure may be implemented.

FIG. 2 illustrates a simplified diagram of a system in which various aspects of the disclosure may be implemented.

FIG. 3 illustrates a method suitable for implementing one or more aspects of this disclosure.

### DETAILED DESCRIPTION

In the following description of the various embodiments, reference is made to the accompanying drawings, which form a part hereof, and in which is shown by way of illustration various embodiments in which one or more aspects of the disclosure may be practiced. It is to be understood that other embodiments may be utilized and structural and functional modifications may be made without departing from the scope of the present disclosure.

Various connections between elements are discussed in the following description. These connections are general and, unless specified otherwise, may be direct or indirect, wired or wireless, and this specification is not intended to be limiting in this respect.

In accordance with various aspects of this disclosure, apparatuses, systems and methods are described for providing product and service offerings. For illustrative purposes the product/service provider discussed throughout the below description is a bank, and the bank is determining whether to extend an account to a user/customer/consumer. However, as those skilled in the art will realize, the described aspects of the disclosure are not limited to banking products and services, but may also include other types of products or services.

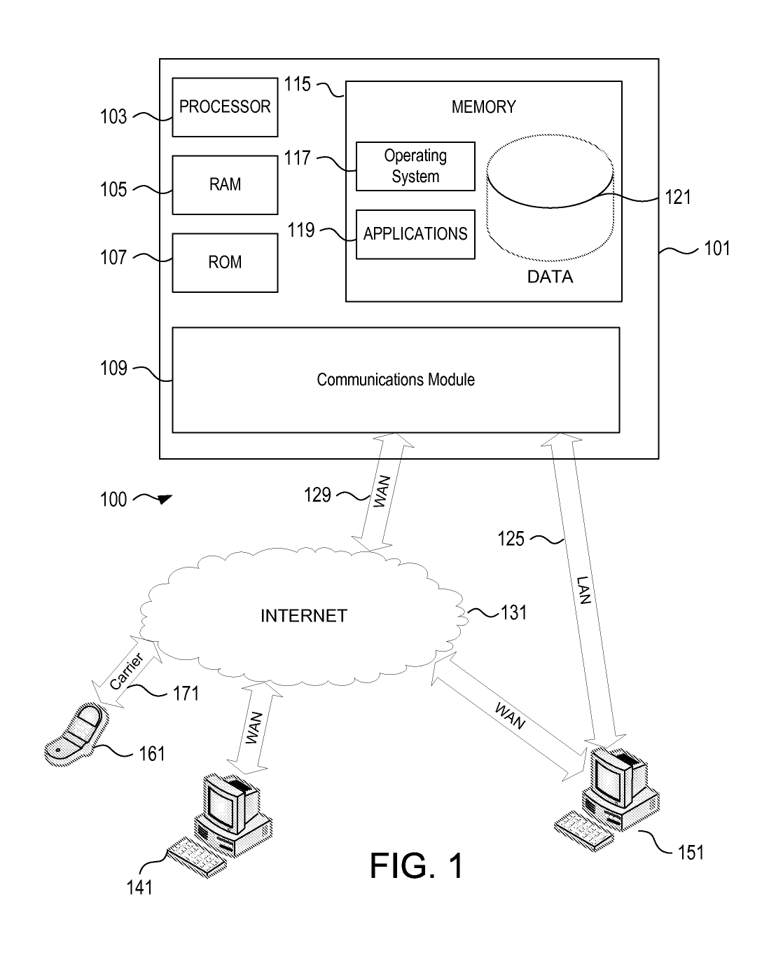

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 825 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 101. Such a processor may execute computer-executable instructions stored on a computer-readable medium.

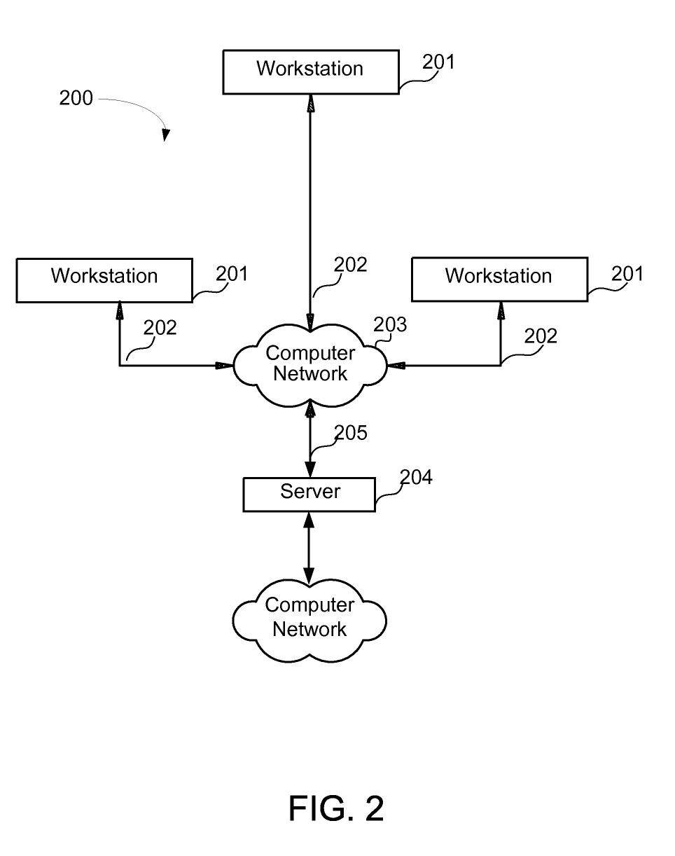

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

In some embodiments, a user may be interested in opening an account with a bank. The account may include one or more product or service offerings, such as support for debit/credit card transactions, checking, bill pay, savings, online banking, and the like. The bank might initially have a limited amount of information available with respect to the user (e.g., the bank may initially have a “thin file” with respect to the user). For example, the bank may initially (only) have a credit score (as reported by one or more credit reporting agencies) associated with the user, along with other information that identifies the user (e.g., name, date of birth, street/residence address, etc.).

In order to obtain access to a greater amount of information regarding the user, particularly information that might inform the decision-making process as to whether to extend an account to the user (and on what terms), the bank may offer one or more incentives to the user to disclose such information. In some embodiments, the additional information may include the user's verified income, which may be evidenced via a tax related form (e.g., a W-2 form, a 1040 form, etc.), a pay stub, or the like. The one or more incentives may include an annual percentage rate (APR) discount, free or discounted (tax) form preparation, cash back, free or discounted checks, free or discounted access to investment advice, free or discounted passport photos, a rebate on another product or service offered by the bank or an affiliate of the bank, etc.

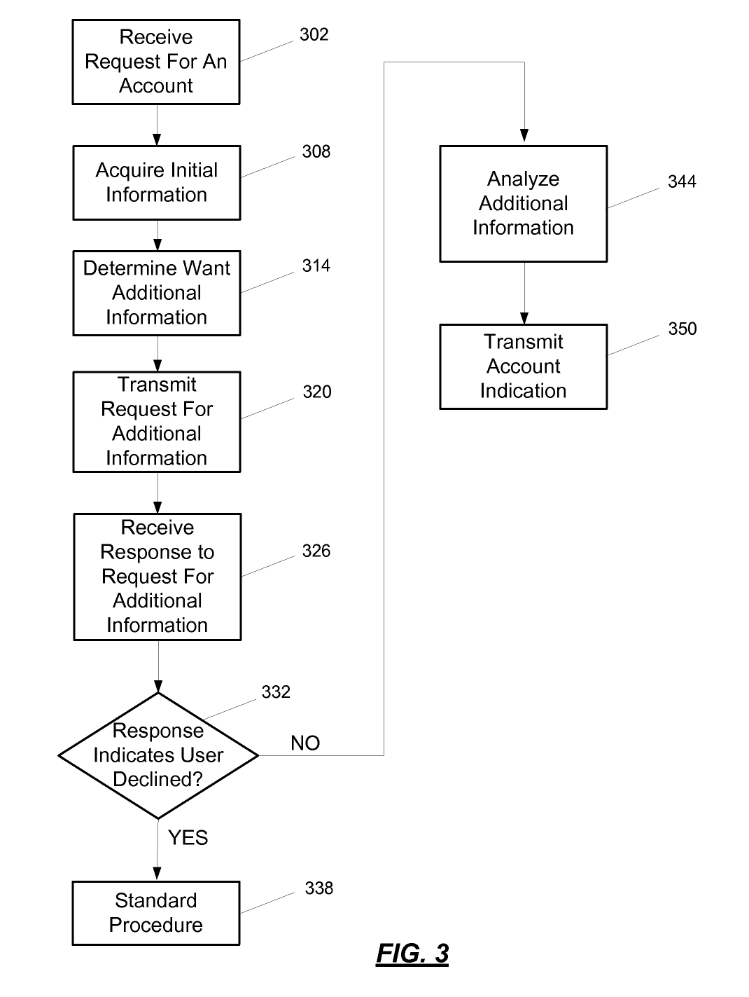

FIG. 3 illustrates a method that may be used to illustrate one or more aspects of this disclosure. The method of FIG. 3 may be operative in one or more environments and/or on one or more computing devices (e.g., the environments and architectures shown in FIGS. 1-2).

In step 302, a request for an account may be received. The request may be the result of a user applying for an account with the bank. In some embodiments, the request of step 302 may be received in response to one or more advertisements by the bank to attract or promote new business. For example, a potential customer using a computing device 101 may access a webpage provided by the bank to request an account.

In step 308, the bank may acquire initial information regarding the user responsive to the request received in connection with step 302. For example, a website of the bank may prompt a potential customer to provide initial information including information that identifies the potential customer. For example, the identification information may include a name, street/residence address, date of birth, a social security number, and the like for an individual. The initial information may further include a credit score as provided by a credit reporting agency (e.g., EQUIFAX, EXPERIAN, TRANSUNION) or the like. For example, a server of the bank may electronically request information about the potential customer from the credit reporting agency. In some embodiments, the initial information may be referred to as a “thin file” in order to draw an analogy to a (physical) file or record having a relatively limited amount of information associated with it.

In step 314, the bank may make a determination that it wants to obtain additional information regarding the potential customer. The determination of step 314 may be based at least in part on a determination that the initial information acquired in connection with step 308 indicates that the user represents a risk or liability within a threshold amount. For example, a bank server may determine that a potential customer could be a risk based on the customer's credit score being within or below a certain range. In some embodiments, the determination of step 314 may be automatically included or generated irrespective of what the initial information acquired in connection with step 308 indicates.

In step 320, the bank may transmit a request for additional or supplemental information. The transmitted request for information associated with step 320 may be in response to the determination associated with step 314. For example, the bank server may use a webpage or an email message requesting the potential customer provide the supplemental information. The request for additional information may include a request for specific information (e.g., (verified) income as indicated on a tax related form, a pay stub, or the like, as well as information on (verified) expenses or expenditures), or may be phrased in more general terms (e.g., “provide any information that reflects on your financial history.”). The request for additional information may provide that participation is voluntary. The request for additional information may state that participation will result in more favorable terms should an offer be extended. In some embodiments, those more favorable terms may be specified as a function of the additional information to be provided (e.g., if you demonstrate that your annual income is above ‘X’, your banking fees will be lower by Y %).

The request for additional information may be received at one or more computing devices, optionally as part of a web page accessible via a web browser or the like. The transmission of step 320 may be conditioned on receiving a credential (e.g., a log-in, a username and password, a PIN, or the like). The use of such a credential may ensure that privacy considerations associated with user information are maintained and to ensure that unauthorized actions are not taken, such as the unauthorized opening of an account.

In step 326, the bank may receive a response from the user in connection with the request for additional information of step 320. The response of step 326 may indicate that the user declined the bank's request for additional information. Alternatively, the response of step 326 may indicate that the user provided additional information (either in its entirety, or that the user provided a subset of the information requested in connection with step 320).

In step 332, a determination may be made in connection with the response received in step 326. If the response indicates that the user declined the bank's request for additional information (e.g., the “YES” path is taken out of step 332), then the flow may proceed to step 338.

In step 338, the bank may proceed in accordance with standard or normal procedures. For example, the bank may decline to extend an offer for an account to the user, or the bank may extend an offer incorporating standard, normal, or customary terms.

If, in step 332, a determination is made that the response of step 326 indicates that the user provided the additional information requested (e.g., the “NO” path is taken out of step 332), then the flow may proceed to step 344.

In step 344, the bank may analyze the additional information provided in the response of step 326, possibly in combination with the initial information acquired in connection with step 308. If the analysis indicates that the user does not represent a risk or liability above a threshold, the bank may make a determination to extend an offer to open an account in the user's name in connection with step 344. The bank may also determine what terms and/or incentives are to be associated with the offer based on the analysis. For example, if the user or potential customer spent less than X % of her income on products or services considered to be “discretionary spending” items (e.g., items not related to food, clothing, or shelter), that user/potential customer may be considered a (low risk) candidate eligible for an offer. Furthermore, if the user or potential customer spent less than Y % of her income on products or services considered to be “discretionary spending” items (where Y is less than X), that user/potential customer may be eligible for an incentive or discount (e.g., a lower interest rate on a credit card to be associated with the account, lower fees due at renewal, etc.). Furthermore, the values associated with the incentive(s) or discount(s) may be a function of how much the user spends on discretionary items. In some embodiments, factors other than discretionary spending may be taken into consideration in determining whether to provide an offer and/or an incentive/discount to a user or potential customer.

In step 350, the bank may transmit an indication of the account to the user. The indication of step 350 may provide that the bank has declined to offer an account to the user if, for example, the analysis of step 344 indicates that providing the user with an account represents too much risk. Alternatively, the indication of step 350 may provide an offer of an account along with terms or conditions based on the analysis of step 344. The indication of step 350 may provide a statement or reasoning as to why the bank reached the decision that it did.

The method described above in connection with FIG. 3 is illustrative. In some embodiments, one or more of the steps (or portions thereof) may execute in an order different from that shown. In some embodiments, one or more of the steps may be optional. In some embodiments, one or more steps not shown may be included. In some embodiments, the acquisition of initial information associated with step 308 may take place in accordance with the receipt of the request for an account (e.g., step 302). For example, as part of an application process (e.g., step 302) a user may disclose the initial information associated with step 308.

The method of FIG. 3 may be used to gain additional insight into a user's (credit, financial) history. Rather than being restricted to a single data point (e.g., a credit score), increased visibility may be obtained in order to evaluate or analyze risk. For example, a user's income and expenses may be obtained and analyzed to determine whether to extend an account to the user (and what terms to associate with that account). In some embodiments, credit lines may be assigned based on disposable income (e.g., income that exceeds expenses).

Aspects of this disclosure may readily be applied to, and adapted to be operative on, one or more communication systems. Those communication systems may include computer networks, television networks, satellite networks, telephone and cellular networks, and the like.

Although not required, various aspects described herein may be embodied as a method, a data processing system, and/or as a transitory and/or non-transitory computer-readable medium storing executable instructions. Accordingly, those aspects may take the form of an entirely hardware embodiment, an entirely software embodiment, an entirely firmware embodiment, or an embodiment combining software, firmware and hardware aspects. The functionality may be resident in a single computing device, or may be distributed across multiple computing devices/platforms, the multiple computing devices/platforms optionally being connected to one another via one or more networks. Moreover, the structural components described herein may be distributed amongst one or more devices, optionally within a common housing or casing.

Various signals representing content, data, information, or events as described herein may be transferred between a source and a destination in the form of electromagnetic waves traveling through signal-conducting media such as metal wires, optical fibers, and/or wireless transmission media (e.g., air and/or space).

The various methods and acts may be operative across one or more computing servers, databases, and one or more networks. The functionality may be distributed in any manner, or may be located in a single computing device (e.g., a server, a database, a client computer, etc.). As discussed herein, content (e.g., product/service offerings and acceptances thereof) may be distributed to intermediary/network components and client-side devices at various times and in various formats. The distribution and transmission techniques described herein may leverage existing components and infrastructure to minimize power dissipation, operational complexity, footprint size, and management involvement, amongst other factors and costs.

The methodological acts and processes described herein may be tied to particular machines or apparatuses. For example, one or more product or service offerings may be transmitted to a user device or location via one or more computing devices (e.g., servers) and the offer(s) may be displayed at the user location via one or more terminals and/or display devices. One or more acceptances, rejections, and/or counter offers may be transmitted from a user device or location to one or more computing devices (e.g., servers). In some embodiments, (additional or supplemental) information regarding a user may be transmitted from a user device or location to one or more computing devices (e.g., servers). More generally, one or more computers may include one or more processors and memory storing instructions, that when executed, perform the methodological acts and processes described herein. Furthermore, the methodological acts and processes described herein may perform a variety of functions including transforming an article (e.g., a “thin file” regarding a user) into a different state or thing (e.g., a supplemented file that may be used to generate one or more product or service offerings with terms based on additional or supplemental information).

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the figures may be performed in other than the recited order, and that one or more steps illustrated may be optional in accordance with aspects of the disclosure.

What is claimed is:

1. An apparatus comprising:
at least one processor; and
at least one memory storing instructions that, when executed by the at least one processor, cause the apparatus at least to:
receive a request for at least one of a financial product and a financial service,
transmit, in response to the received request, a request for information comprising a request for verified income information and an offer for an incentive for disclosing the verified income information,
receive a response to the request for information and determine whether the response comprises the verified income information,
wherein if the response comprises the verified income information:
determine eligibility for the at least one of the financial product and the financial service based on the verified income information, and
in response to finding eligibility, causing providing of the at least one of the financial product and the financial service, and the incentive, and
wherein if the response does not comprise the verified income information:
determine eligibility for the at least one of the financial product and the financial service based on a credit score, and
in response to finding eligibility, causing providing of the at least one of the financial product and the financial service, but not the incentive.

2. The apparatus of claim 1, wherein the request for information is transmitted as a web page.

3. The apparatus of claim 1, wherein the instructions, when executed by the at least one processor, cause the apparatus to:
analyze a subset of information included in the received response,
wherein the providing of the at least one of the financial product and the financial service comprises an offer based at least in part on the analyzed subset of information.

4. The apparatus of claim 1, wherein the request for at least one of a product and a service comprises an application for a bank account.

5. The apparatus of claim 1, wherein the request for information comprises a request for expenses.

6. The apparatus of claim 1, wherein the request for verified income comprises a request for at least one of a W-2 form and a 1040 form, and wherein the response comprises the at least one of a W-2 form and a 1040 form.

7. The apparatus of claim 1, wherein the at least one incentive comprises at least one of an annual percentage rate (APR) discount, free or discounted form preparation, cash back, tax preparation, investment advice, and a rebate for purchasing a second at least one product and service.

8. The apparatus of claim 1, wherein the instructions, when executed by the at least one processor, cause the apparatus to:
determine that the response comprises an indication that a user declined to provide information in response to the request for information, and
responsive to determining that the response comprises an indication that a user declined to provide information in response to the request for information, extend an offer for the at least one of a product and a service to the user using customary terms.

9. A method comprising:
receiving a request for at least one of a product and a service;
generating and transmitting, by a server, a request for information in response to the received request, the transmitted request for information comprising at least one incentive for disclosing the information; and
receiving a response to the request for information.

10. The method of claim 9, further comprising:
determining that the received response includes at least a subset of information requested by the request for information; and
responsive to determining that the received response includes at least a subset of information requested by the request for information, transmitting an offer for the at least one of a product and service.

11. The method of claim 10, further comprising:
analyzing the subset of information included in the received response,
wherein the transmitted offer is based at least in part on the analyzed subset of information and includes the at least one incentive as a function of the analysis.

12. The method of claim 9, wherein the request for at least one of a product and a service comprises a request for a bank account, and wherein the bank account provides support for debit and credit card transactions, checking, bill pay, savings, and online banking.

13. The method of claim 9, wherein the request for information comprises a request for income and a request for expenses.

14. The method of claim 13, wherein the request for income comprises a request for at least one of a W-2 form, a 1040 form, and a pay stub.

15. The method of claim 9, wherein the at least one incentive comprises at least one of an annual percentage rate (APR) discount, free or discounted form preparation, cash back, and a rebate for purchasing a second at least one product and service.

16. A non-transitory computer-readable medium comprising instructions that, when executed by an apparatus, cause the apparatus to:
receive a request for at least one of a product and a service,
transmit a request for information in response to the received request, the transmitted request for information comprising at least one incentive for disclosing the information, and
receive a response to the request for information.

17. The non-transitory computer-readable medium of claim 16, wherein the instructions, when executed by the apparatus, cause the apparatus to:
determine that the received response includes at least a subset of information requested by the request for information, and
responsive to determining that the received response includes at least a subset of information requested by the request for information, transmit an offer for the at least one of a product and service.

18. The non-transitory computer-readable medium of claim 17, wherein the instructions, when executed by the apparatus, cause the apparatus to:
analyze the subset of information included in the received response,
wherein the transmitted offer is based at least in part on the analyzed subset of information and includes the at least one incentive as a function of the analysis.

19. The non-transitory computer-readable medium of claim 16, wherein the request for information comprises a request for verified income and a request for expenses.

20. The non-transitory computer-readable medium of claim 16, wherein the instructions, when executed by the apparatus, cause the apparatus to:
determine that the response comprises an indication that a user declined to provide information in response to the request for information, and
responsive to determining that the response comprises an indication that a user declined to provide information in response to the request for information, perform at least one of: decline to extend an offer for the at least one of a product and a service to the user and extend an offer for the at least one of a product and a service to the user using customary terms.
